(19) United States
(12) Patent Application Publication
(10) Pub. No.: US 2010/0330940 A1
(43) Pub. Date: Dec. 30, 2010

(54) SENSOR-AIDED WIRELESS COMBINING

(75) Inventors: Leonid SHEYNBLAT, Hillsborough, CA (US); Douglas Neal ROWITCH, Del Mar, CA (US); Ardalan HESHMATI, Saratoga, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/875,735

(22) Filed: Sep. 3, 2010

Related U.S. Application Data
(63) Continuation-in-part of application No. 11/932,628, filed on Oct. 31, 2007.
(60) Provisional application No. 60/863,631, filed on Oct. 31, 2006.

(51) Int. Cl. H04B 7/00; H04B 1/04; H04B 1/06

(52) U.S. Cl. 455/129; 455/277.1

(57) ABSTRACT

An apparatus and method are disclosed for achieving receiver diversity. A wireless unit includes a plurality of antennas, an antenna selector to select one or more antennas from the plurality of antennas, a processor with input data from an inertial sensor for monitoring the orientation of the wireless unit. Based on the input data, the processor commands the antenna selector to select one or more antennas. In some embodiments, the processor is a diversity processor. Based on the input data from the inertial sensor, the diversity processor computes the combination of the received signals. In another aspect, the wireless unit further includes a baseband processor to process the output of the diversity processor for a particular unit application.

### RELATED APPLICATION

This application is a continuation-in-part application that claims the benefit under 35 U.S.C. 120 of U.S. application Ser. No. 11/932,628, entitled “Apparatus and Method for Sensor-based Wireless Receive Diversity”, filed Oct. 31, 2007, which is incorporated herein by reference in its entirety, and which claims priority from U.S. Provisional Application 60/863,631, entitled “Sensor-based GPS Receive Diversity”, filed on Oct. 31, 2006, and which is also incorporated herein by reference in its entirety.

### BACKGROUND OF THE INVENTION

1. Field of the Invention

This disclosure relates generally to sensor-adjusted wireless reception, and in particular, to apparatus and methods for adjusting a receive path based on measurements from a spatial sensor.

2. Description of the Related Art

In wireless communication systems, the strength and direction of the signal sources vary as the wireless unit moves in location. The strength of the signal sources also vary as the wireless unit moves in relative orientation. Most wireless units communicate through electromagnetic radio waves with a cell site base station. The signals from the cell site base station are received through an antenna mounted on the wireless unit. Typically, the antenna on a wireless unit is an approximation of an isotropic antenna or dipole antenna. A theoretical model of an isotropic antenna radiates and receives power in all directions uniformly. In practice, a perfect isotropic antenna is not achievable. Similarly, a dipole antenna radiates equally in the plane perpendicular to the antenna axis. Given these patterns, the antennas radiates and receives equally well in most directions without favoring a particular direction. This results in a low antenna gain near 0 dBi for an isotropic antenna and near 2.15 dBi for a dipole antenna. Therefore, an apparatus, system and method are needed to improve signal reception and experienced antenna gain.

### SUMMARY

According to one aspect, a wireless unit for antenna selection is presented, the wireless unit comprising: a plurality of antennas comprising antennas having at least two different antenna patterns; an antenna selector comprising a plurality of ports each coupled to a respective one of the plurality of antennas and a control port to accept a control signal to select at least one of the plurality of antennas; an inertial sensor comprising a data port to provide orientation information indicative of the orientation of the wireless unit; and a processor coupled to the data port of the inertial sensor and coupled to the control port of the antenna selector, wherein the processor is configured to generate the control signal based on the orientation information.

According to another aspect, a wireless unit to combine signals is presented, the wireless unit comprising: a plurality of antennas comprising at least one directional antenna; an inertial sensor comprising a data port to provide orientation information indicative of the orientation of the wireless unit; a combiner comprising a plurality of input ports each coupled to at least one of the plurality of antennas and further comprising a control port to receive a control signal used to combine signals from the plurality of input ports; and a processor coupled to the data port of the inertial sensor and coupled to the control port of the combiner, wherein the processor is configured to generate the control signal based on the orientation information.

According to another aspect, a method to combine signals using a wireless unit is presented, the method comprising: providing a plurality of antennas comprising at least one directional antenna; sensing, using an inertial sensor, an orientation of the wireless unit and generating orientation information indicative of the orientation of the wireless unit; generating a control signal based on the orientation information; and combining signals from a plurality of antennas based on the control signal.

According to another aspect, a wireless unit to combine signals is presented, the wireless unit comprising: means for providing a plurality of antennas comprising at least one directional antenna; means for sensing, using an inertial sensor, an orientation of the wireless unit and for generating orientation information indicative of the orientation of the wireless unit; means for generating a control signal based on the orientation information; and means for combining signals from a plurality of antennas based on the control signal.

According to another aspect, a computer-readable product comprising a computer-readable medium is presented, comprising: code to cause at least one computer to sense, using an inertial sensor, an orientation of a wireless unit and to generate orientation information indicative of the orientation of the wireless unit; code to cause at least one computer to generate a control signal based on the orientation information; and code to cause at least one computer to combine signals from a plurality of antennas based on the control signal.

It is understood that other aspects will become readily apparent to those skilled in the art from the following detailed description, wherein it is shown and described various aspects by way of illustration. The drawings and detailed description are to be regarded as illustrative in nature and not as restrictive.

### BRIEF DESCRIPTION OF THE DRAWINGS

FIG. 1 is an illustration of an antenna gain pattern of an approximately dipole antenna.

FIG. 2 is an illustration of an approximation of a hemispherical antenna gain pattern.

FIG. 3 is an illustration of a directional antenna gain pattern.

FIG. 4 is a block diagram of an aspect of a wireless unit with an inertial sensor and two antennas.

FIGS. 5A through 5D illustrate the geometry of an inertial sensor and antenna patters relative to a horizontal plane and a direction to a remote antenna.

FIG. 6 is an illustration of another aspect of a wireless unit with diversity reception capability.

FIG. 7 is a block diagram of an aspect of a wireless unit with baseband processing capability.

FIG. 8 is a block diagram of a second aspect of a with baseband processing capability.

FIG. 9 is a block diagram of a third aspect of a wireless unit with baseband processing capability.

FIG. 10 is a block diagram of a fourth aspect of a wireless unit with baseband processing capability.

FIG. 11 is a general block diagram of a single-receive path general navigation satellite system (GNSS) receiver.

FIG. 12 is a block diagram of a dual-receive path GNSS receiver, which may used for diversity reception.

FIG. 13 is a block diagram of a multi-path GNSS receiver using an orientation sensor and information about transmitter positions, in accordance with some embodiments of the present invention.

FIGS. 14A and 14B show determined orientations of a mobile device and directions to various transmitters.

FIG. 15 shows the use of a relative position processor to perform switched diversity.

FIG. 16 shows the use of a relative position processor to compute weights for non-coherent combining.

FIG. 17 shows the use of a relative position processor to compute phase offsets for coherent combining.

### DETAILED DESCRIPTION

The detailed description set forth below in connection with the appended drawings is intended as a description of various aspects of the present invention and is not intended to represent the only aspects in which the present invention may be practiced. Each aspect described in this disclosure is provided merely as an example or illustration of the present invention, and should not necessarily be construed as preferred or advantageous over other aspects. The detailed description includes specific details for the purpose of providing a thorough understanding of the present invention. However, it will be apparent to those skilled in the art that the present invention may be practiced without these specific details. In some instances, well-known structures and devices are shown in block diagram form in order to avoid obscuring the concepts of the present invention. Acronyms and other descriptive terminology may be used merely for convenience and clarity and are not intended to limit the scope of the invention.

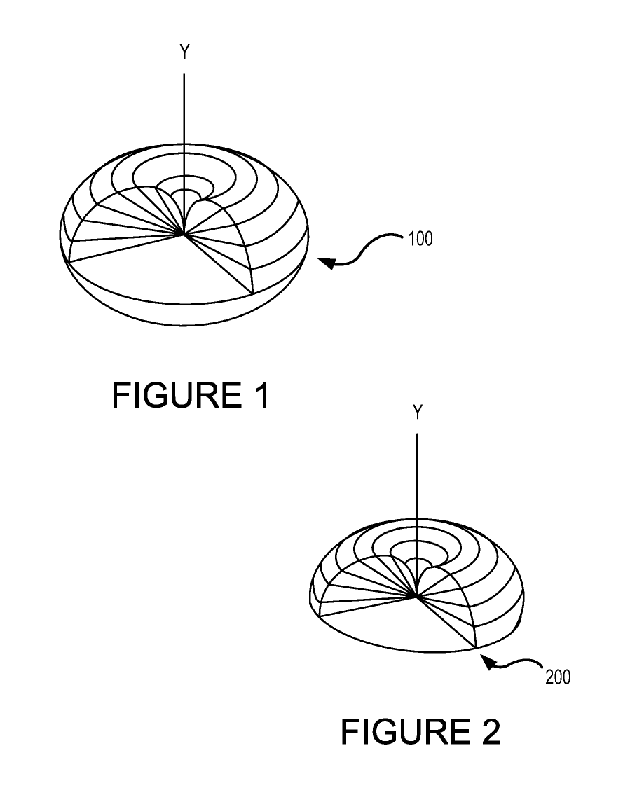

FIG. 1 is an illustration of an antenna gain pattern 100 of a half-way dipole antenna or omni-directional antenna. The antenna gain is approximately uniform in all directions with respect to the Y axis. Thus, the approximately dipole antenna radiates and receives power uniformly in all directions in the X-Z plane, but at a reduced antenna gain compared to other more directional antennas. A theoretic isotropic antenna radiates uniformly in all directions with respect to the X-Y-Z axes.

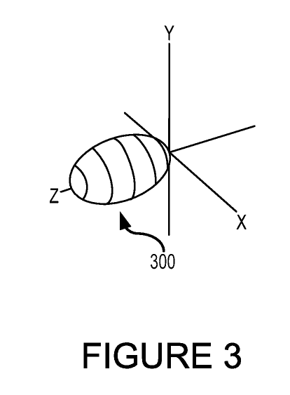

FIG. 2 shows an antenna gain pattern 200 providing an approximation of a hemispherical antenna gain pattern. The antenna gain pattern 200 has about a 3-dB gain increase over the antenna pattern 100 of the approximately dipole antenna. The gain increase is due to the fact that the radiation pattern is confined to the upper hemisphere only.

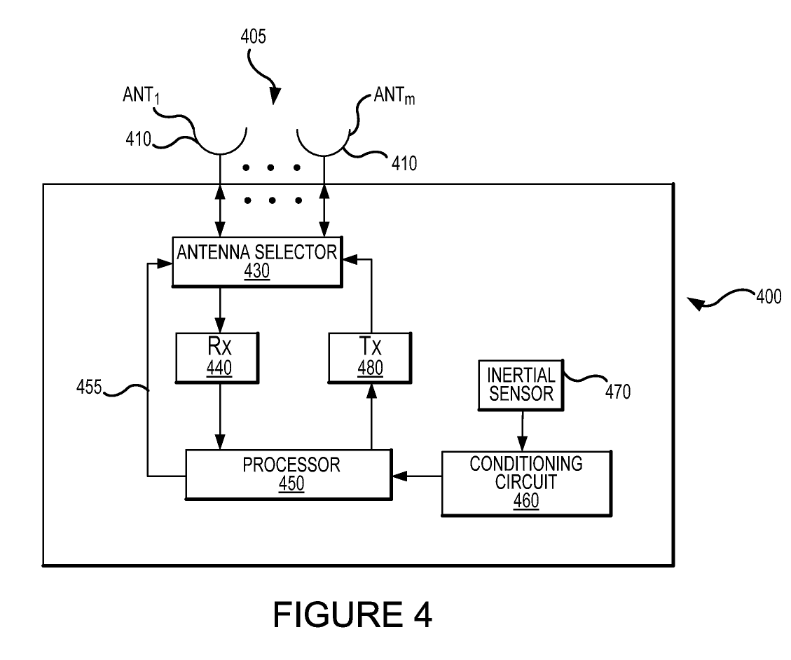

FIG. 3 is an illustration of a directional antenna gain pattern 300. The gain of a directional antenna is greater than that for a hemispherical antenna depending on the directivity of the antenna pattern. Examples of directional antennas include helix antenna, horn antenna, dipole array antenna, patch antenna, etc. There are many examples of antennas with their respective gain patterns, and that antenna gain patterns are dependent on the directivity of the antenna patterns.

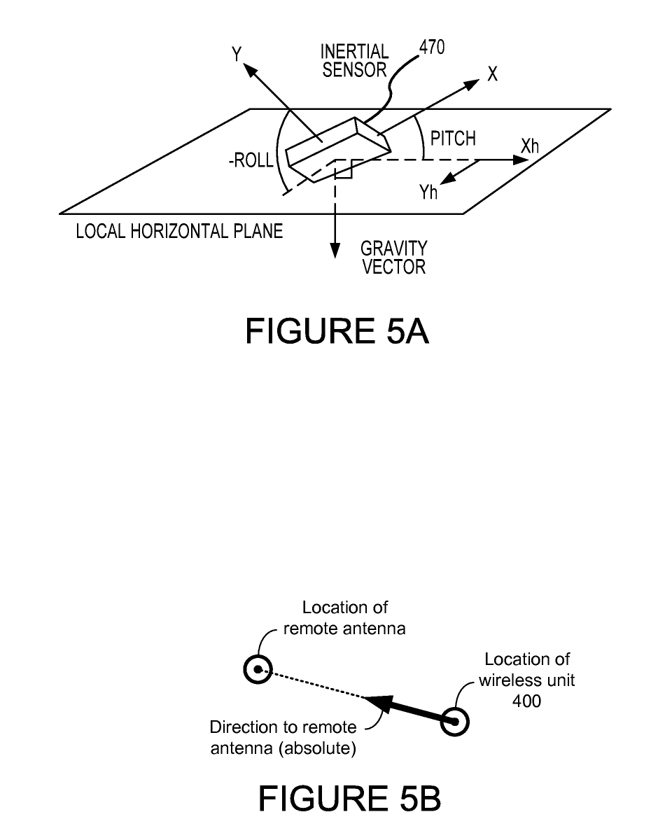

FIG. 4 is a block diagram of an aspect of a wireless unit 400 with an inertial sensor 470 and a plurality of antennas 410. The wireless unit 400 also includes an antenna selector 430, a receiver 440, a processor 450, a conditioning circuit 460, an inertial sensor 470 and a transmitter 480. A wireless unit 400 may be a fixed, handheld or portable mobile phone, personal data device (PDA), tracking device, and/or the like.

The antenna selector 430 is coupled to the antennas 410 to receive a signal 405. The antenna selector 430 provides an antenna signal to the receiver 440 based on an antenna selection input 455. The receiver 440 provides a received signal to the processor 450 for processing. Processing is based on a sensor signal from the inertial sensor 470. As shown, the inertial sensor 470 provides its sensor signal to the conditioning circuit 460 prior to providing the sensor signal to the processor 450. The processor 450 also provides transmit data to the transmitter 480, which provides a transmit signal to the antenna selector 430.

As shown, there are m antennas 410 receiving signal 405 to the antenna selector 430, which forwards the received signals to the receiver 440. The quantity of antennas, as disclosed here, is not confined to a particular quantity, and that the quantity of antennas is chosen based on the particular system parameters.

In some embodiments, the plurality of antennas includes at least one dual-polarized antenna. In one example, a dual-polarized antenna could include horizontal and vertical polarization to provide two diversity outputs which are then fed into a switch, a selector, a combiner or equivalent circuitry. In other embodiments, the plurality of antennas reflects the diversity outputs of one or more dual-polarized antennas. A single dual-polarized antenna could be the equivalent in spirit to two distinct, spatially separated antennas.

The signal 405 is received by one or more of the antennas 410. The antenna selector 430, based on an antenna selection input 455 from the processor 450, selects one or more from the plurality of antennas to receive the signal 405. The signal 405 received by the selected one or more antenna(s) is then sent as an input signal to the receiver unit 440 and then to the processor 450 for processing. In some embodiments, a typical receiver unit could include one or more of the following components for processing the signal 405: a bandpass filter, a low noise amplifier (LNA), a mixer, local oscillator (LO), a low pass filter, an analog to digital converter, etc. Other embodiments of a receiver unit are well known and would not change the scope of the present disclosure. In some embodiments, a plurality of receivers is implemented with the plurality of antennas wherein the plurality of antennas could be greater in quantity to the plurality of receivers. In other embodiments, the plurality of antennas is equal in quantity to the plurality of receivers. In some embodiments, the plurality of receivers refers to the receiver outputs in a multi-channel receiver.

The inertial sensor 470 measures the orientation of the wireless unit 400 in an inertial reference frame. The orientation information, measured by the inertial sensor 470, is then sent as an input signal to the processor 450 to generate the antenna selection input 455. The orientation information measured by the inertial sensor 470 is used to support the antenna selection to improve the chance of finding the desired signal at a desirable signal strength or to improve antenna gain. For example, if the orientation of the wireless unit 400 is known, that orientation information is used to select the antenna, and the selected antenna with a higher gain can be directed to receive the desired signal in its direct path and reduce multipath effect.

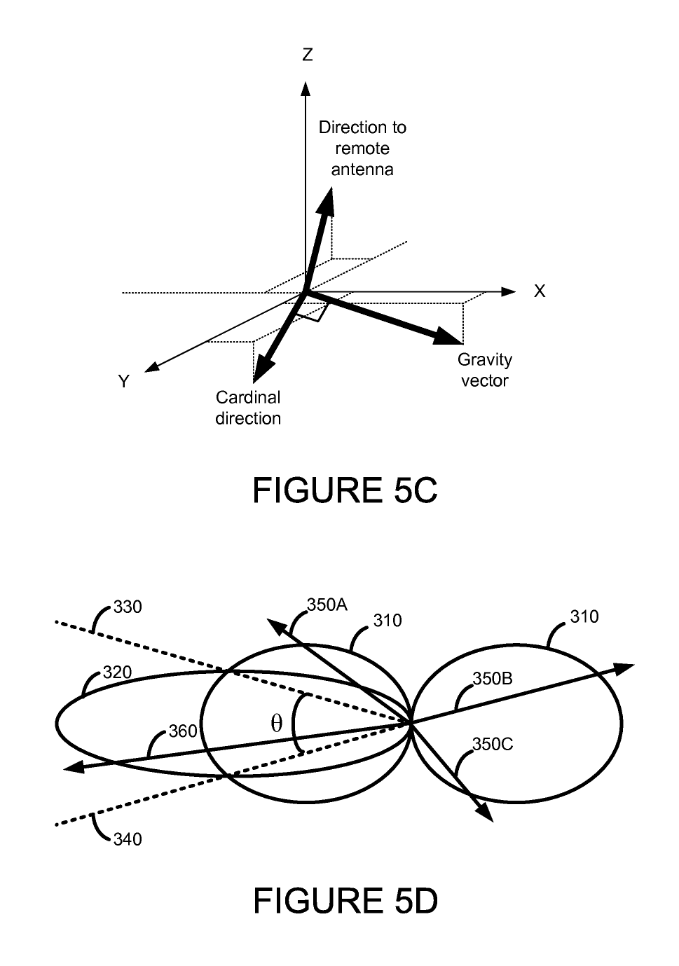

FIG. 5A illustrates the geometry of an inertial sensor 470 relative to a local horizontal plane. The local horizontal plane is defined as being perpendicular to the gravity vector. The orthogonal axis system (X-Y) of the inertial sensor 470 is compared with the orthogonal axis system (Xₕ-Yₕ) of the local horizontal plane to determine the orientation of the inertial sensor 470 relative to the horizontal plane.

Examples of inertial sensor 470 include accelerometers, quartz sensors, gyros, etc. Referring back to FIG. 4, the orientation of the wireless unit 400 determines the selection among the two or more antennas 410. In some embodiments where two antennas are implemented, one antenna is an approximately isotropic or dipole antenna and the other antenna is a hemispheric antenna or directional antenna. For example, if the wireless unit 400 is in communication with base stations surrounding its geographical location, the approximately isotropic antenna may be selected because the antenna gain pattern of an isotropic antenna allows for uniform radiation in all directions as described above. However, for example, if the wireless unit 400 is in receipt of signals from the Global Navigational Satellite System (GNSS), and the antennas of wireless unit 400 are oriented toward the GNSS satellites as determined by the inertial sensor 470, the antenna selector 430 is then directed by the processor 450 to select the hemispheric antenna to take advantage of higher antenna gain. Signals from GNSS satellites include but are not confined to signals from GPS satellites, and/or satellites from any other satellite system, including but not limited to, GLONASS, Galileo, COMPASS (Beidou), QZSS and IRNS. Additionally, the source of the signals is not limited to GNSS and could include other satellite positioning systems (SPSs) or any other wireless source, such as but not limited to, pseudolite systems, WiFi, CDMA, Bluetooth, etc.

In another example, where two antennas are implemented, assume that one of the two antennas is a directional antenna. For this example, the source of the signal 405 is from a particular direction. Using the orientation information measured by the inertial sensor 470, the directional antenna of the wireless unit 400 is selected to radiate and receive signal from the desired direction of the source, maximizing the antenna gain. In another example, if signals are received from both terrestrial pseudolite sources and satellite sources, selection between two antennas (for example, a directional antenna and a hemispheric antenna) can be made based on the orientation of the wireless unit 400 as measured by the inertial sensor 470. The combination of the types of antenna is numerous and its choice would depend on the design of the system and the system application.

In some embodiments, a conditioning circuit 460 is used to transduce or convert measurements received from the inertial sensor 470 to a form compatible with the processor 450. For example, the output of the inertial sensor 470 may be in an analog format. The conditioning circuit 460 converts the analog data format to a digital data format for input into the processor 450. In another example, the output of the inertial sensor 470 is amplified in the conditioning circuit 460 to a signal level that is acceptable for input into the processor 450. Different conditioning circuits with different transducing properties may be used based on the choice of inertial sensor 470 and the processor 450. Also, in some embodiments, a conditioning circuit may not be needed.

Some wireless units 400 select an antenna based solely on a relative pitch and roll of the wireless unit 400. For example, knowing the direction of the gravity vector relative to the wireless unit 400, a wireless unit 400 may select an antenna which is most closely orients antenna transmission and/or reception in the horizontal plane. Other wireless units 400 select an antenna (or antennas) based on knowing a direction to a remote transmitter or receiver. For example, the wireless unit 400 knows an absolute direction to the remote transmitter or receiver. The wireless unit 400 also can determine a relative orientation (pitch and roll) to the gravity vector. Some wireless units 400 may also be able determine a heading (i.e., a relative direction between the wireless unit 400 and a cardinal direction).

FIG. 5B shows a location of a wireless unit 400, a location of a remote antenna and a directional vector between the two locations. Before selecting an antenna, a vector showing the absolute direction from the wireless unit 400 to the remote antenna may be computed, for example, by finding the location of each end point. The location of the wireless unit 400 may be determined from a GPS fix at the wireless unit 400, power measurements at the wireless unit 400 and/or neighboring base stations, and the like. The location of the remote antenna may similarly be determined from a broadcast or similar message or other direction finding techniques at the wireless unit 400.

FIG. 5C shows the relative relationship between the direction vector to the remote antenna, the cardinal vector and the gravity vector with respect to the coordinate system internal to the wireless unit 400. The Gravity vector may be determined by an internal sensor 470. The internal sensor 470 or secondary sensor may be used to determine the cardinal vector (e.g., pointing North). The gravity vector will define a local horizontal plane perpendicular to the gravity vector. The cardinal vector lies within this horizontal plane and is thus perpendicular to the gravity vector as shown. The direction vector to the remote antenna is independent of both the cardinal vector and the gravity vector. Once the absolute direction from the wireless unit 400 to the remote antenna and the absolute orientation of the wireless unit 400 are determined, an antenna with a maximum gain in the direction of the remote antenna is selected.

FIG. 5D illustrates the relative geometry between two example antennas. A first antenna radiates and receives a first antenna pattern 310 (e.g., a dipole antenna pattern shown as a cross section of the antenna patent 100 of FIG. 1). A second antenna has a second antenna pattern 320 (e.g., from a directional antenna pattern 300 shown in FIG. 3). Depending on a position of a remote receiver or a remote transmitter, a wireless unit 400 may select the antenna with greater gain to that remote location. That is, instead of basing antenna selection solely on the relative position between the wireless unit 400 and the Earth in the direction of the gravity vector, embodiments select one or more antennas based on the combination of a relative position between the wireless unit 400 and the Earth and an absolute orientation from a current location of the wireless unit 400 and a direction to a remote receiver or remote transmitter.

The inertial sensor 470 is used to determine a relative orientation of the wireless unit 400 and the Earth. In some embodiments, the inertial sensor 470 may only be able to distinguish a relative position between the wireless unit 400 and a gravity vector. That is, an absolute angle in the horizontal plane is unknown. In these embodiments, a pitch and a roll may be determined but an angle perpendicular to the gravity vector may be unknown but determinable based on a different sensor or separate processing (e.g., based on an internal compass or by comparing signal strengths of a common signal source). The processor may also use the inertial sensor 470 or other sensor (e.g., such as a GPS receiver or signal strength meter) to determine a direction between the wireless unit 400 and the remote receiver or remote transmitter. Combining the knowledge of the relative orientation of wireless unit 400 to the Earth and the direction from the wireless unit 400 to the remote receiver or transmitter, the processor may determine an optimal antenna or set of antennas to use.

For example, within a conic section within 330 and 340 and represented by angle theta (A), the second antenna provides a greater gain than the first antenna. Outside the angle theta (A), the first antenna provides a greater gain. Based on information from the inertial sensor 470 and knowledge of the location of remote receivers (r transmitters, the processor 450 may determine an absolute direction from the wireless unit 400 to the remote receiver or transmitter. An internal sensor 470 may determine the real-world orientation of the wireless unit 400. With knowledge of the location of a satellite or a base station, the wireless unit 400 may determine an absolute direction to that satellite or base station. For example, the wireless unit 400 may determine a first receiver or transmitter is located in a direction 360, which is shown to be within the conic section between 330 and 340. In this case, the second antenna (e.g., the directional antenna) has a greater gain so the processor 450 will provide an antenna selection signal 455 to the antenna selector 450 such that the second antenna is used. Similarly, if the wireless unit 400 determines another receiver or transmitter is located in a direction 350A, 350B or 350C, which are shown to be outside the conic section between 330 and 340, the first antenna (e.g., the dipole antenna) has a greater gain so the processor 450 will provide an antenna selection signal 455 to the antenna selector 450 such that the first antenna is used.

FIG. 5E shows a process of selecting an internal antenna based on the direction to a remote antenna and an absolute device orientation. At step 560, an absolute direction from the wireless unit 400 to the remote antenna is determined For example, this vector may be formed by determining the location of the wireless unit 400 and also determining the location of the remote antenna.

At step 562, the absolute direction from the wireless unit 400 to the remote antenna is converted to a direction relative to the wireless unit 400. To determine the relative direction, an orientation of the wireless unit 400 may be determined first. For example, the orientation of the wireless unit 400 may be determined by determining the gravity vector (down) thereby determining a direction with respect to the X-Y plane. The orientation may be further refined by determining an orientation within the local horizontal plane. For example, a cardinal direction may be determined by use of the sensor 470 or secondary sensor (providing a compass direction).

At step 564, an antenna is selected based on the relative direction to the remote antenna. That is, an antenna is selected based on the device orientation and the direction to the remote antenna. An antenna may be selected that provides the greatest gain in the direction of remote antenna from the perspective of the device in its current determine orientation.

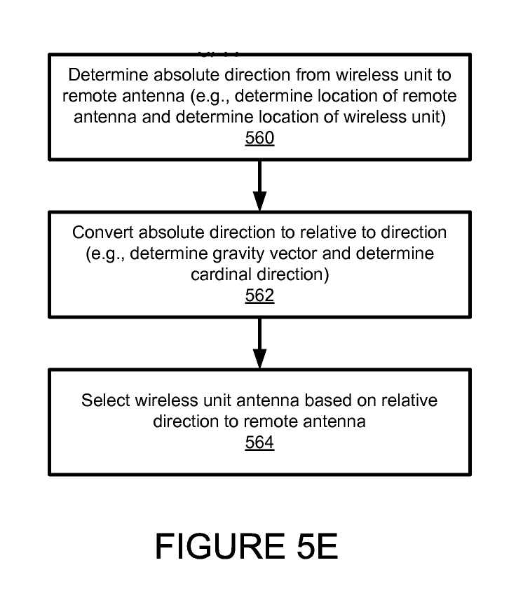

FIG. 6 is an illustration of another aspect of a wireless unit 400 with diversity reception capability. As illustrated in FIG. 6, the wireless unit 400 includes a plurality of antennas (ANT₁ . . . ANTₘ) 510. In one example, the quantity m equals 2. Other quantities of antennas where m>2 may be desirable depending on the system parameters. The plurality of antennas (ANT₁ . . . ANTₘ) 510 include a combination of antenna providing at least two different antenna patterns.

The wireless unit 400 also includes a multi-channel receiver 520 to receive a plurality of signals 515 and to convert the plurality of signals 515 into received formats. In some embodiments, the multi-channel receiver 520 includes one or more of the following components for processing the plurality of signals 515: a bandpass filter, a low noise amplifier (LNA), a mixer, local oscillator (LO), a low pass filter, an analog to digital converter, etc. Other aspects of a multi-channel receiver are well known and would not change the scope of the present disclosure.

The receiver outputs (Z₁ . . . Zₙ) 525 of the multi-channel receiver 520 are sent as input signals to a diversity processor 530. The diversity processor 530 processes the receiver output signals (Z₁ . . . Zₙ) 525 into an output signal Y 535. In some embodiments, the output signal 535 is further digitally processed to suit the system application.

The number of receiver outputs (Z₁ . . . Zₙ) 525 may correspond to the number of active antennas (ANT₁ . . . ANTₘ) 510. In this case, n=m. However, in some embodiments, the quantity of receiver outputs n is less than the quantity of antennas implemented m (i.e., n<m). For example, one implementation could include one receiver and two antennas to choose from. In other embodiments, the quantity of receiver outputs n is greater than the quantity of antennas implemented m (i.e., n>m). In the case where n=1, the receiver 520 provides a single signal 525 and there is no diversity combining. The implementation of a multi-channel receiver could vary without affecting functionality. For example, a receiver with multi-channel capabilities could be implemented with multiple single channel receivers without affecting functionality.

In some embodiments, the diversity processor 530 computes the weighted average of the receiver outputs (Z₁ . . . Zₙ) 525 and outputs an output signal 535 representative of that weighted average. In one example, the output signal 535 (labeled here as Y) is defined as Y=Σwᵢ Zᵢ, where i=1 n and the parameters wᵢ are the weighting parameters.

Many other examples of diversity processing are well known and the particular choice of a diversity processing is based on the particulars of the system design. In some embodiments, the receiver outputs (Z₁ . . . Zₙ) 525 are coherently combined with their phase offset from each other estimated. In other embodiments, the receiver outputs (Z₁ . . . Zₙ) 525 are non-coherently combined. In some embodiments, an antenna selection input 455 from the diversity processor 530 is received by the multi-channel receiver 520 to implement selection of which antennas (ANT₁ . . . ANTₘ) 510 to use. The antenna selection input 455 is based on results measured by the inertial sensor 470.

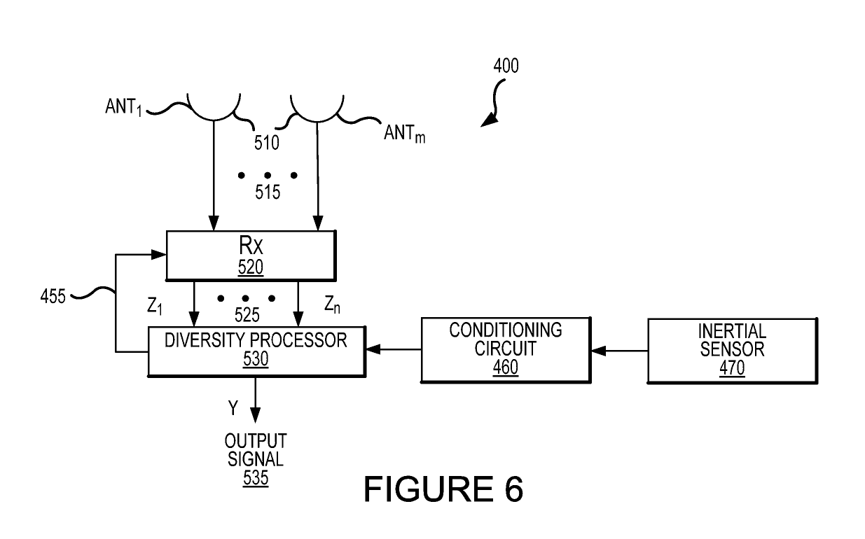

FIG. 7 is a block diagram of an aspect of the wireless unit 400 with baseband processing capability. In some embodiments, a diversity processor is in analog format and includes an analog phase rotator and diversity combiner. The wireless unit 400 includes a multi-channel receiver 520 to receive a plurality of signals 515 from a corresponding plurality of antennas (ANT₁ . . . ANTₘ) 510 and to convert the plurality of signals 515 into receiver output signals (Z₁ . . . Zₙ) 525 where n>=1.

An analog diversity processor 532 accepts the receiver output signals (Z₁ . . . Zₙ) 525 and provides an output signal P₇. Following the analog diversity processor 532, the output P₇ is converted from analog format to digital format by ADC 720 and then processed by the digital baseband processor A 730 to output a baseband signal S₇. In some embodiments, the ADC 720 includes a sampler and a quantizer to convert the analog format input to digital format. In some embodiments, the digital baseband processor A 730 performs phase rotation, de-spreading, coherent accumulation and non-coherent accumulation to recover the baseband signal S₇.

In some embodiments, an antenna selection input 455 from the diversity processor 530 is received by the multi-channel receiver 520 to implement selection of which antenna or antennas (ANT₁ . . . ANTₘ) 510 to use. The antenna selection input 455 is based at least in part on results measured by the inertial sensor 470. For example, an inertial sensor 470 may be used to determine the relative orientation between the wireless unit 400 containing the sensor and the horizontal plane with respect to the Earth. Such knowledge may be used to select an antenna (or antennas) most likely having the strongest gain with respect to a remote receiver or transmitter.

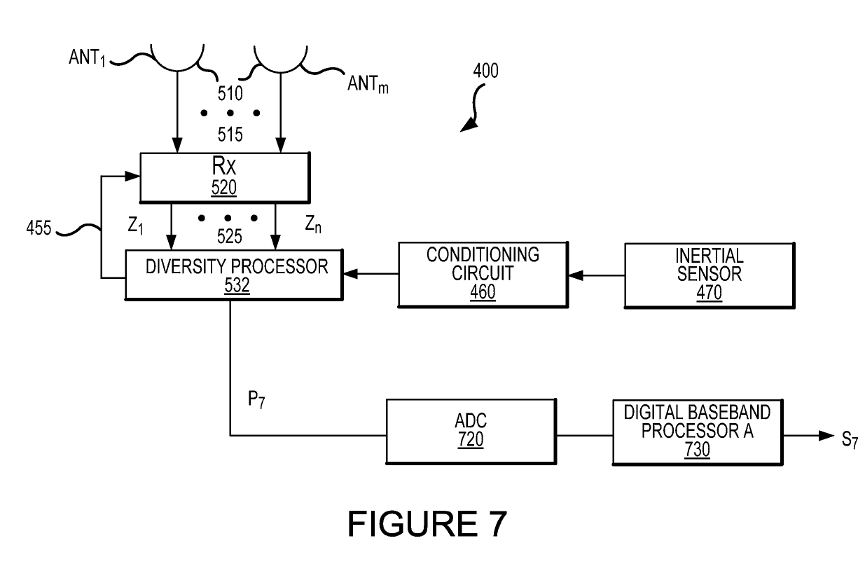

FIG. 8 is a block diagram of a second aspect of the wireless unit 400 with baseband processing capability. The diversity processor 534 is in digital format and performs coherent sampling and diversity combining on the receiver outputs (Z₁ . . . Zₙ) 525. In other embodiments, the coherent sampling may be performed by a separate unit (not shown) coupled to the diversity processor 534. There are various implementations known which can be employed without affecting the scope of the disclosure. In some embodiments, the digital baseband processor B 830 performs phase rotation, de-spreading, coherent accumulation and non-coherent accumulation on the output P₈ to recover the baseband signal S₈. In some embodiments, an antenna selection input 455 from the diversity processor 530 is received by the multi-channel receiver 520 to implement selection of which antennas (ANT₁ . . . ANTₘ) 510 to use. The antenna selection input 455 is based on results measured by the inertial sensor 470.

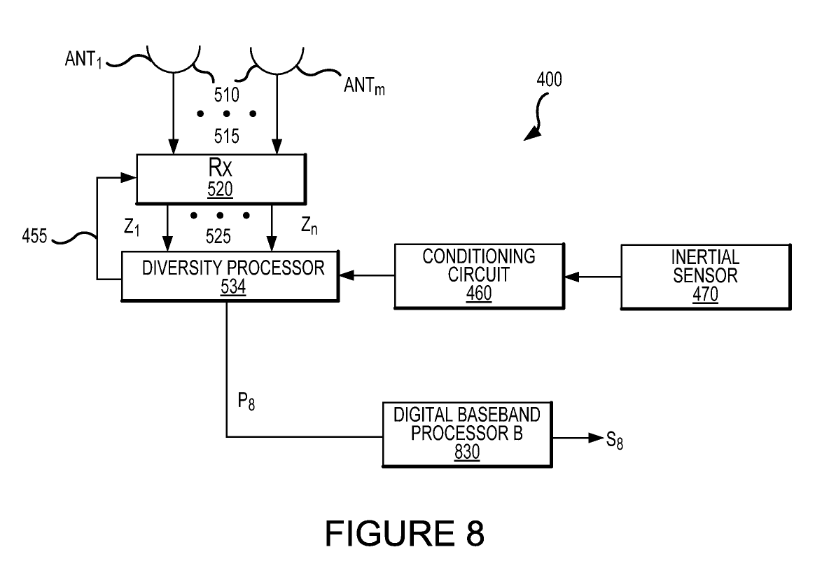

FIG. 9 is a block diagram of a third aspect of a wireless unit 400 with baseband processing capability. In some embodiments, the diversity processor 940 is in digital format. Baseband processor A 930 receives receiver outputs (Z₁ . . . Zₙ) 525 for baseband processing, and outputs processor A outputs (Pa₁ . . . Paₙ) which are sent as an input signal to the diversity processor 940. The diversity processor output D from the diversity processor 940 is then sent as an input signal to baseband processor B 950 for further processing to recover baseband signal S₉. Baseband processor A 930 and baseband processor B 950 can be implemented either by a single processor unit or by separate processor units. In some embodiments, baseband processor A 930, diversity processor 940 and baseband processor B 950 are all implemented by a single processor unit.

In some embodiments, the baseband processing performed by the baseband processor A 930 includes phase rotation, de-spreading and coherent accumulation of each receiver outputs (Z₁ . . . Zₙ) 525. Outputs (Pa₁ . . . Paₙ) from Processor A 930 are sent as an input signal into the diversity processor 940. In some embodiments, the diversity processing performed by the diversity processor 940 includes accumulating and diversity combining the outputs (Pa₁ . . . Paₙ) from processor A 930. In some embodiments, the diversity processor 940 coherently accumulates the processor A outputs (Pa₁ . . . Paₙ). The diversity processor output D is sent as an input signal to baseband processor B 950. In some embodiments, processor B 950 performs further coherent accumulation and non-coherent accumulation to recover baseband signal S₉. The quantity of outputs (Pa₁ . . . Paₙ) from processor A 930 corresponds to the quantity of receiver outputs (Z₁ . . . Zₙ) 525. In some embodiments, an antenna selection input 455 from the diversity processor 940 is received by the multi-channel receiver 520 to implement selection of which antennas (ANT₁ . . . ANTₘ) 510 to use. The antenna selection input 455 is based on results measured by the inertial sensor 470 as described above.

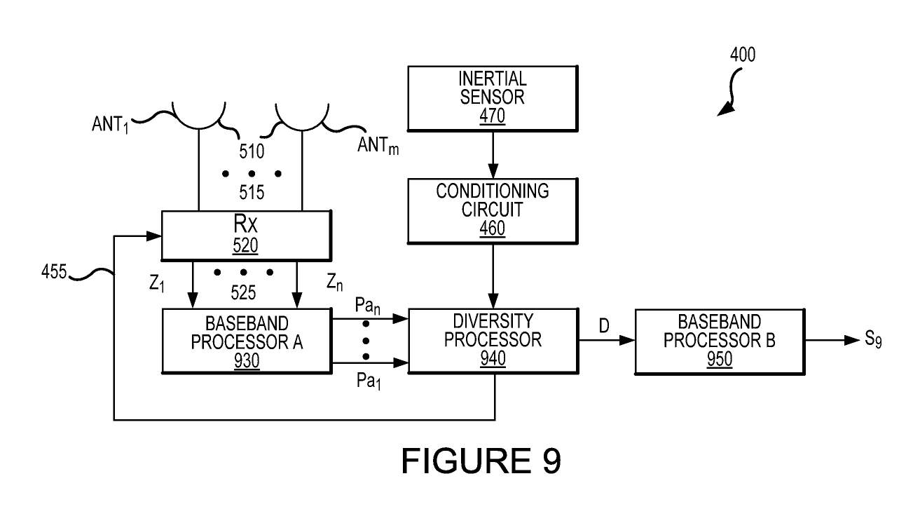

FIG. 10 is a block diagram of a fourth aspect of a wireless unit 400 with baseband processing capability. In some embodiments, the diversity combining is done non-coherently. The receiver outputs (Z₁ . . . Zₙ) 525 are sent as an input signal into baseband processor C 1030. Baseband processor C 1030 phase rotates, despreads, accumulates (either coherently or non-coherently) the receiver outputs (Z₁ . . . Zₙ) 525 to generate processor C outputs (Pc₁ . . . Pcₙ). Processor C outputs (Pc₁ . . . Pcₙ) are then sent as an input signal to the diversity processor 1040, which non-coherently accumulates the processor C outputs (Pc₁ . . . Pcₙ) and non-coherently diversity combines them to recover baseband signal S₁₀. Baseband processor C 1030 and diversity processor 1040 can be implemented either by a single processor unit or by separate processor units. In some embodiments, an antenna selection input 455 from the diversity processor 1040 is received by the multi-channel receiver 520 to implement selection of which antennas (ANT₁ . . . ANTₘ) 510 to use. Again, the antenna selection input 455 is based on results measured by the inertial sensor 470.

As shown in FIGS. 6-10, the wireless unit 400 includes an inertial sensor 470 which measures the orientation of the wireless unit 400 in an inertial reference frame. Examples of inertial sensors 470 include accelerometers, quartz sensors, gyros, etc. Based on the measured orientation of the wireless unit 400, an orientation information is generated by the inertial sensor 470 and sent as an input signal to the diversity processor. In some embodiments, the orientation information affects how the diversity processor processes and combines its inputs. Depending on the orientation of the wireless unit 400 relative to one or more of the signal sources (which may be embedded in orientation information), different weighting coefficients may be applied to one or more of the inputs. In the embodiments shown in FIGS. 6-8, the inputs to the diversity processor 530 are receiver outputs (Z₁ . . . Zₙ) 525. In the embodiments shown in FIG. 9, the inputs to the diversity processor 940 are processor A outputs (Pa₁ . . . Paₙ). And, in the embodiments shown in FIG. 10, the inputs to the diversity processor 1040 are processor C outputs (Pc₁ . . . Pcₙ). In some embodiments, the orientation information affects the selection of antennas (ANT₁ . . . ANTₘ) 510 to use, as implemented by the antenna selection input 455.

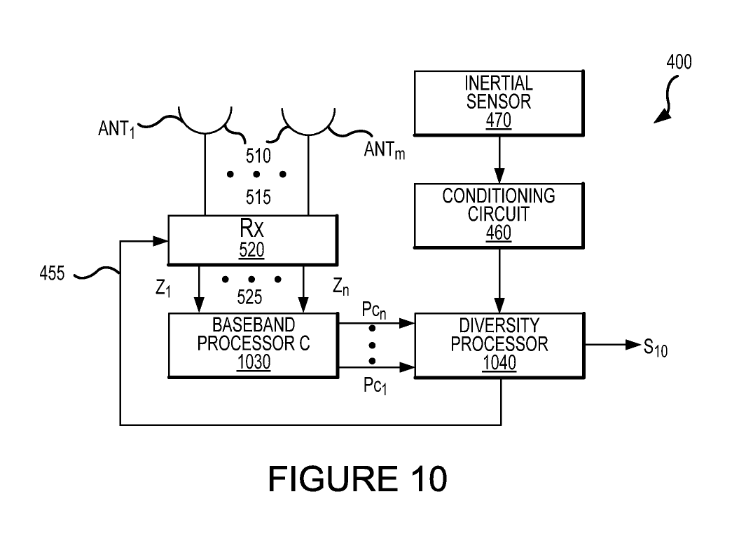

FIG. 11 is a general block diagram of a single-receive path general navigation satellite system (GNSS) receiver. The receiver includes an analog front end comprising an antenna to receive signals from one or more positioning satellites 54a, a band pass filter (BPF) 521, a low noise amplifier (LNA) 522, a mixer and associated local oscillator (LO) 523 and a low pass filter (LPF) 524. The receiver also includes digital receiver chain comprising a sample and hold circuit 525, an analog-to-digital converter (ADC) 526 and a digital baseband processor 730. As described above, the digital baseband processor 730 performs phase rotation, de-spreading, coherent accumulation and non-coherent accumulation.

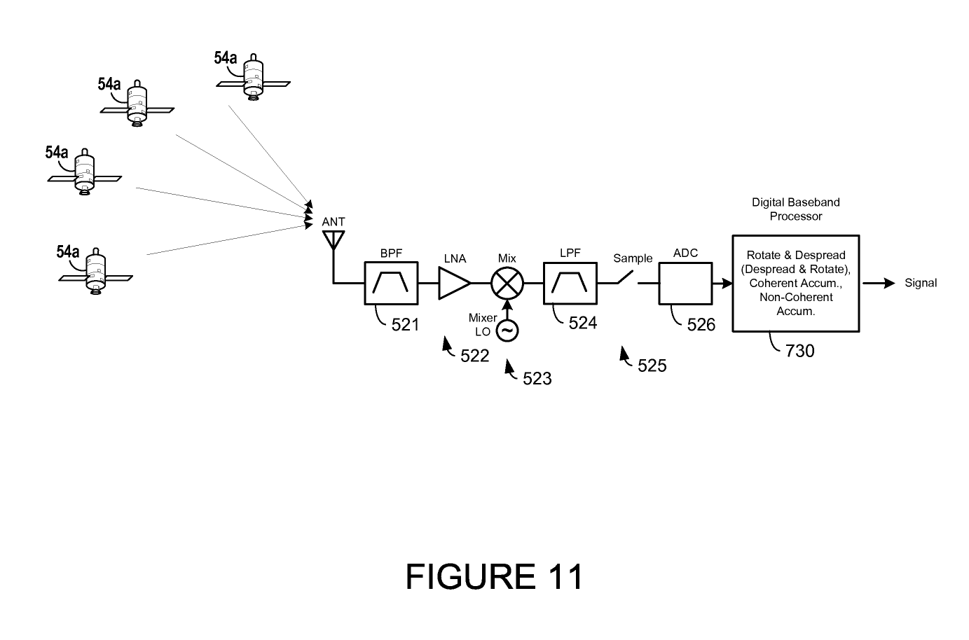

FIG. 12 is a block diagram of a dual-receive path GNSS receiver, which may used for diversity reception. A first antenna (ANT₁) receives a signal along a first respective path from each of one or more positioning satellites 54a. Similarly, a second antenna (ANT₂) receives a signal along a second respective path from each of the one or more positioning satellites 54a. Each antenna signal is passed through a separate receiver chain comprising a band-pass filter BPF 521, a low-noise amplifier LNA 522, a mixer 532, a low-pass filter LPF 524 and a digital converter including a sampler 525 and an analog-to-digital converter ADC 526. The mixers 523 may each receive a coherent local oscillator signal either in or out of phase from each other.

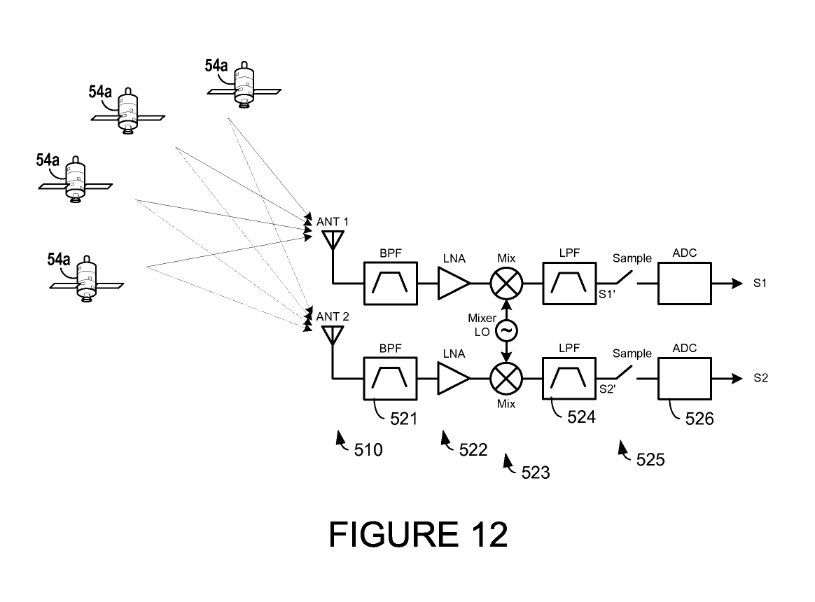

FIG. 13 is a block diagram of a wireless unit 400 including a multi-path GNSS receiver 520, an orientation sensor 570 and information about transmitter position, in accordance with some embodiments of the present invention. The block diagram shows a multi-path receiver 520 coupled to a plurality of antennas (ANT₁, ANT₂, . . . , ANTₘ) 510 and providing a receive signal. The receive signal may contain an information signal that will be subsequently demodulated. The antennas may be coupled to the multi-path receiver 520 via a conductive path for providing the information signal. In one example, the quantity m equals 2. Other quantities of antennas where m>2 may be desirable depending on the system parameters. The plurality of antennas (ANT₁ . . . ANTₘ) 510 include a combination of antenna providing at least two different antenna patterns. That is, the antennas are engineered such that they provide at least two different antenna patterns about the wireless unit 400. A means for providing a plurality of antennas includes an array of two or more equivalent antennas each placed against a different surface of the wireless unit 400. Another means for providing a plurality of antennas includes a group of two or more different antennas each providing different coverage with different antenna patterns. For example, a first of the plurality of antennas may be an omni-directional antenna placed in a first orientation within the wireless unit 400 while a second of the plurality of antennas may be placed perpendicular to the first orientation. Alternatively, the first antenna may be a directional antenna and the second antenna may be an omni-directional antenna. Yet in another alternative, the first antenna may be a directional antenna and the second antenna may be an hemispheric antenna. The circuitry describe below assists the wireless unit in selecting one of the plurality of antennas or in combining and weighting two or more of the plurality of antennas.

The block diagram also includes a relative position processor 560 providing a control signal 455 to the multi-path receiver 520. The signal 455 provides an indication of relative position between the local reference system and the plurality of antennas. The control signal 455 is used to determine which one antenna or weighted combination of antenna signals from the plurality of signals will be provided as the output receive signal from the multi-path receiver 520. The control signal 455 may select which one of the plurality of antennas is expected to provide a strongest signal between the wireless unit and a remote transmitter. Alternatively, the control signal 455 may select which two or more of the plurality of antennas that are expected to provide the strongest signals. The strongest signals may be determined based on which signal is expected to provide the strongest overall power (P_{MAX}), the highest signal-to-noise ratio (SNR), the highest signal-plus-interference-to-noise ratio (SINR), the lowest bit-error rate (BER) or other quality metric. Furthermore, the remote transmitter may be assumed a terrestrial base station or access point located horizontally from the wireless unit 400.

Alternatively, the remote transmitter may be assumed an orbiting satellite located vertically from the wireless unit 400.

The relative position processor 560 includes an orientation sensor 570, a processor 590 and a relative transmitter position unit 580, each of which may be implemented in hardware, software or the combination of hardware and software. The relative position processor 560 may determine an absolute location of a remote transmitter based on the information signal from the transmitter position unit 580. In this case, the control signal is generated based on the determined angle. In some embodiments, the relative position processor 560 determines angle between a reference orientation of the wireless unit and an angle to a remote transmitter. For example, if the wireless unit 400 is tiled vertically at a 45-degree angle and a transmitter is directly north, the relative position processor 560 will select one or more antennas with an antenna pattern directed towards the north.

The orientation sensor 570 acts as a means for sensing and generating a signal indicating an orientation of the wireless unit 400. The orientation sensor 570 includes an inertial sensor comprising a data port to provide orientation information indicative of the orientation of the wireless unit 400. The orientation sensor 570 determines an orientation of the mobile device relative to a local reference system. That is, it describes the orientation of the wireless unit with respect to a vertical orientation (up and down) and/or horizontal orientation (e.g., cardinal or magnetic directions). The orientation sensor 570 may include a gyroscope or other means to determine a vertical orientation (i.e., a direction of gravity). The orientation sensor 570 may include a magnetometer or similar means to determine a horizontal orientation. Based on the orientation sensor 570, the wireless unit can determine its orientation with respect its environment.

The relative transmitter position unit 580 determines a direction between one or more transmitters and the wireless unit 400. The relative transmitter position unit 580 may act as a means for determining an absolute location of a remote transmitter based on the information signal. For example, the wireless unit 400 determines a direction from the wireless unit 400 to the nearest transmitter. In other embodiments, the relative position processor 560 includes an orientation sensor 570 and a processor 590 but a relative transmitter position unit 580. Without specific transmitter information from a relative transmitter position unit 580, the transmitters may be assumed to be terrestrial. In this case, the control signal 455 selects antennas, based on the current orientation of the wireless unit 400, having antenna patterns projected in the horizontal plane. Alternatively, the transmitters may be assumed to be in positioning satellites. In this case, the control signal 455 may select antennas, again based on the current orientation of the wireless unit 400, having antenna patterns projected vertically.

The processor 590 acts as a means for generating a control signal 455 based on the orientation information. The processor 590 may also act as a means for determining a relative direction from the wireless unit 400 to a remote transmitter. The processor 590 is coupled to the data port of the orientation sensor 570 and coupled to the control port of the antenna selector via the control signal 455. In operation, the processor 590 generates the control signal 455 based on the orientation information from the orientation sensor 570. The processor 590 may also accept directional signals from the relative transmitter position unit 580. Based on the orientation and directional signals, the processor 590 may determine which one or combination of antenna signals is expected to provide an optimal signal for the current orientation and position of the wireless unit.

The configuration above uses a relative position processor for input signals. That is, the arrangement is used to determine the position of remote transmitters relative to a wireless unit and select one or more of its antennas to receive one or more signals. A complementary arrangement may be used for output signals. That is, the wireless unit 400 may be configured to determine the position of remote receivers and select one or more antennas to transmit more or more signals. In this case, the receiver 520 providing received signal is replaced by a transmitter receiving a transmit signal. The relative position processor 560 then is used to determine a relative direction to a receiver rather than the relative direction from a transmitter. The relative position processor 560 similarly selects which one or more antennas the transmitter will use to send the transmit signal.

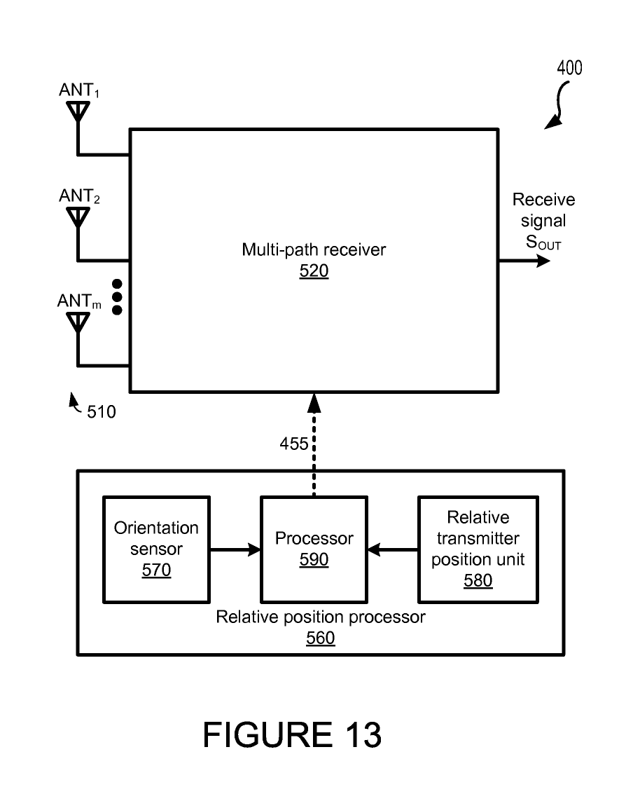

FIGS. 14A and 14B show determined orientations of a mobile device and directions to various transmitters. In FIG. 14A, a wireless unit 400 is shown with an arbitrary orientation (device orientation) in space with respect to a reference orientation vector. The device orientation may be determined by the orientation sensor 570 of FIG. 13. In some embodiments, the device orientation vector provides a three-dimensional orientation, as shown, of the wireless unit 400. In other embodiments, the device orientation vector provides a two-dimensional orientation, such as a horizontal orientation provided by a magnetometer. Still in other embodiments, the device orientation vector provides a single-dimensional orientation, such as a vertical orientation provided by an accelerometer.

In FIG. 14B, a wireless unit 400 is shown at an arbitrary position in space with respect to various transmitters and a corresponding set of position vectors. Each position vector represents a direction (or equivalently, a relative direction) from the wireless unit 400 to a specific transmitter. A first position vector shows a direction from the wireless unit 400 to a nearby positioned base station (BS). The set of position vectors may include just the closest base station or the closest two or three base stations. A second vector shows a direction from the wireless unit 400 to a positioning satellite, such as a GPS satellite. The set of position vectors may additionally include just the closest GPS satellite, the GPS satellite most directly above the wireless unit 400, or two, three or four of such positioning satellites.

Each vector runs from the position of the wireless unit 400 to a position of the transmitter. The positions may be determined by the relative transmitter position unit 580 of FIG. 13. The device position may be determined using a satellite positioning system (e.g., GPS, Galileo or GLONASS system) and/or terrestrial positioning systems (e.g., cell-based trilateration or triangulation). The transmitter position may be predefined and/or stored in the wireless unit 400. For example, the wireless unit 400 may be able to determine positions in the sky of one or more satellites based on the current time. Similarly, the wireless unit 400 may have a table of predetermine base station and/or access point positions. The positions may be transmitted from a network to the mobile or may have been determined by the wireless unit 400 during a previous encounter. In some embodiments, each vector is provided in terms of a three-dimensional directional vector, as shown, from the wireless unit 400 to a transmitter. In other embodiments, the vector provides only a two-dimensional displacement, such as a vector in a horizontal plane, between the wireless unit 400 and the transmitter. Still in other embodiments, the device orientation vector provides a single-dimensional orientation, such as a vertical orientation provided by an accelerometer.

Based on the device orientation and the direction vector(s), the wireless unit determines which one or more antennas to select for receiving a signal. Some embodiments incorporate a switch to select a single antenna thereby performing switch diversity. Other embodiments weight and combine multiple antenna input signals either coherently with a coherent combiner or incoherently with a non-coherent combiner.

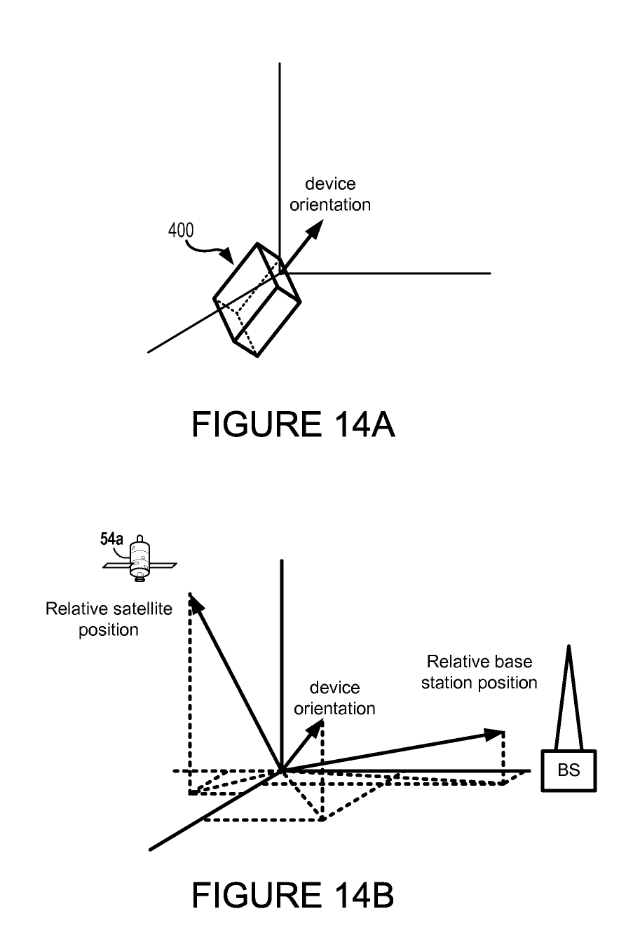

FIG. 15 shows the use of a relative position processor 560 to perform switched diversity. The block diagram shows a wireless unit 400 including a single-path receiver 520 providing a receive signal (S). The receiver 520 is coupled to a plurality of antennas (ANT₁, ANT₂, . . . , ANTₘ) 510 via a switch 528. In some embodiments, the switch 528 switches radio frequency (RF) input signals. In other embodiments, the switch 528 switches intermediate frequency (IF) input signals. The relative position processor 560, described above with reference to FIG. 13, provides a control signal 455 used to select an antenna input signal. The switch passes the selected antenna input signal to the receiver 520 for demodulation to result in the received signal S.

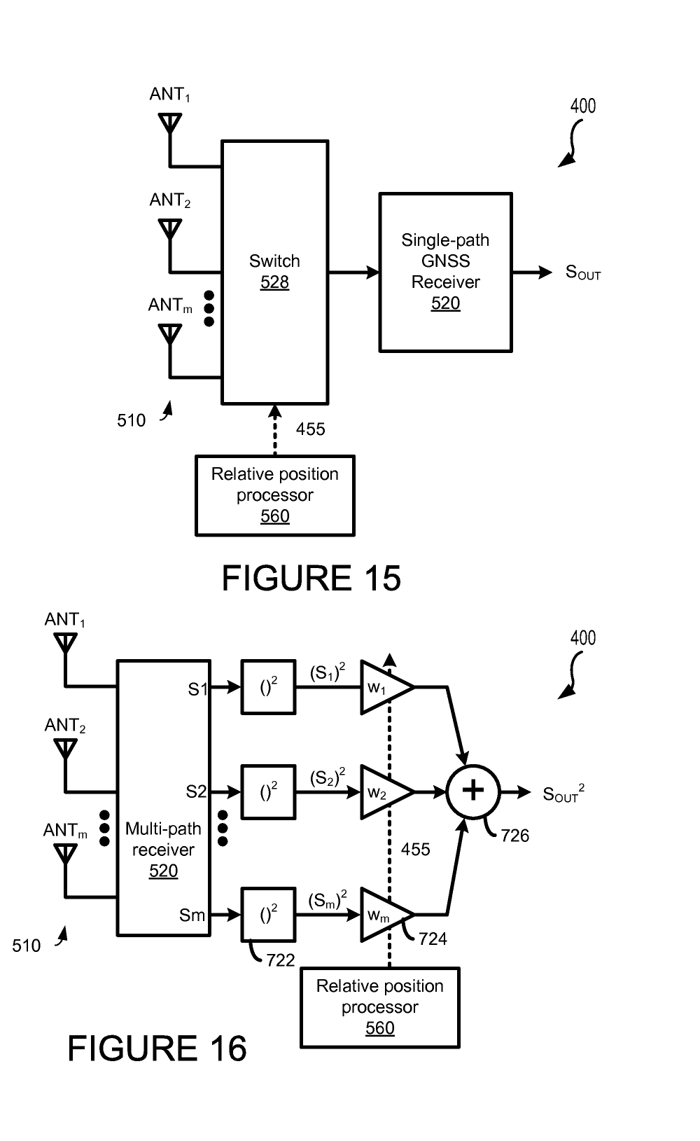

FIG. 16 shows the use of a relative position processor 560 to compute weights for non-coherent combining. The block diagram shows a wireless unit 400 including a multi-path receiver 520 coupled to a plurality of antennas (ANT₁, ANT₂, . . . ANTₘ) 510 and providing a corresponding plurality of receive signals (S₁, S₂, . . . , Sₘ). The multi-path receiver 520 may pass the antenna signals through or down convert the RF signals to IF or base band signals. The plurality of receive signals (S₁, S₂, . . . , Sₘ) are provided to squaring, weighting and summing circuitry. The squaring, weighting and summing circuit provides a squaring unit 722 and a weighting unit 724 for each receive signal (S₁, S₂, . . . , Sₘ). The squaring unit 722 accepts a receive signal (S₁, S₁, . . . , Sₘ) and outputs a squared signal (S₁², S₂², . . . , Sₘ²). The weighting unit 724 weights each squared signal (S₁², S₂², . . . , Sₘ²) with a respective weight (w₁, w₂, . . . , wₘ). For example, a signal S₂ from the second antenna (ANT₂) is squared by squaring unit 722, then weighted by a value w₂ by unit 724 resulting in a squared and weighted product w₂(S₂)². The respective weights (w₁, w₂, . . . , wₘ) are set by the control signal 455 from the relative position processor 560. The relative position processor 560 sets this control signal 455 based on the orientation of the wireless unit 400 and the position of one or more transmitters relative to the wireless unit 400. For example, the weights may be set based on an expected received signal strength from each antenna. For example, the weights may be set to (0.0, 0.4 and 0.6). After squaring and weighting, the resulting signals are summed by summer 726 to produce a received signal (S_{OUT}²). The summer combines signals from a plurality of antennas based on the control signal 455. The summer acts as a means for combining multiple signals. An adder, a combiner, a digitizer and a digital processor, or other summer implemented in hardware and/or software may be used as a means for combining

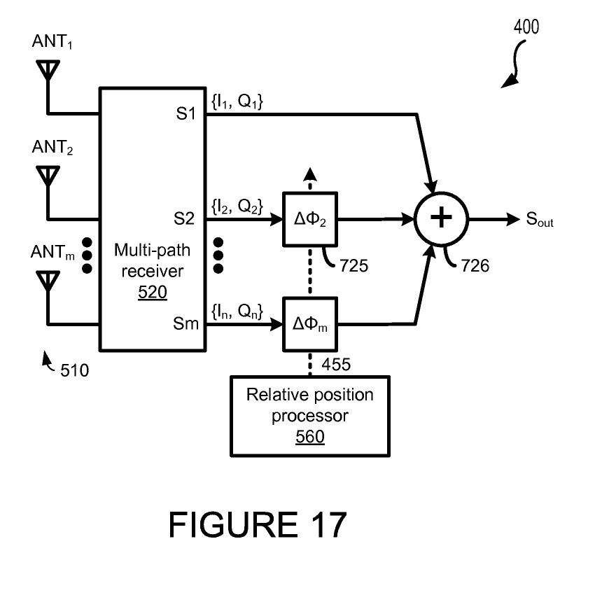

FIG. 17 shows the use of a relative position processor to compute phase offsets for coherent combining The diagram shows a wireless unit 400 that includes a plurality of antennas (ANT₁, ANT₂, . . . ANTₘ) 510, a multi-path receiver 520, a relative position processor 560, phase compensators 725 and a summer 726. The multi-path receiver 520 includes m antenna inputs to receive signals from the plurality of antennas (ANT₁, ANT₂, . . . ANTₘ) 510 and m output to provide received signals (Sᵢ, S₂, . . . , Sₘ). Each signal Sᵢ includes an in-phase component and an out-of-phase component {IᵢQᵢ}.

Based on the orientation of the wireless unit 400 and the relative transmitter positions of one or more transmitters, the relative position processor 560 determines a relative orientation from the current orientation of the wireless unit 400 to the one or more transmitters. With this information the relative position processor 560 generates phase adjustment signals 455 to direct antenna reception from one or more transmitters.

Variable phase adjustment signals (Δφ₂, Δφₘ) control respective phase compensators 725. The phase compensators 725 also receive corresponding signals (S₂, . . . , Sₘ) from the multi-path receiver 520. The variable phase adjustment signals (Δφ₂, . . . Δφₘ) are set based on the control signal from the relative position processor 560. In turn, the phase compensators 725 use the variable phase adjustment signals (Δφ₂, . . . Δφₘ) to adjust the phase of the incoming in-phase and out-of-phase signal components {IᵢQᵢ} of signals (S₂, . . . , Sₘ). The phase compensators 725 use the control signals to adjust the phase of each of the signals (S₂, . . . , Sₘ) such that each has a phase common with an estimated phase of signal S₁. Combining the signal S₁ with phase adjust signals with summer 726 results in a coherently combined output signal S_{OUT}.

The described system above may be implemented in a combination of hardware and software. For example, the wireless unit 400 may contain code for causing at least one computer to: (1) sense, using an inertial sensor, an orientation of the wireless unit and to generate orientation information indicative of the orientation of the wireless unit; (2) generate a control signal based on the orientation information; and (3) combine signals from a plurality of antennas based on the control signal.

The various illustrative logical blocks, modules, and circuits described herein may be implemented or performed with one or more processors. A processor may be a general purpose processor, such as a microprocessor, a specific application processor, such a digital signal processor (DSP), or any other hardware platform capable of supporting software. Software shall be construed broadly to mean any combination of instructions, data structures, or program code, whether referred to as software, firmware, middleware, microcode, or any other terminology. Alternatively, a processor may be an application specific integrated circuit (ASIC), a programmable logic device (PLD), a field programmable gate array (FPGA), a controller, a micro-controller, a state machine, a combination of discrete hardware components, or any combination thereof The various illustrative logical blocks, modules, and circuits described herein may also include machine readable medium for storing software. The machine readable medium may also include one or more storage devices, a transmission line, or a carrier wave that encodes a data signal.

The previous description of the disclosed aspects is provided to enable any person skilled in the art to make or use the present invention. Various modifications to these aspects will be readily apparent to those skilled in the art, and the generic principles defined herein may be applied to other aspects without departing from the spirit or scope of the invention.

1. A wireless unit for antenna selection, the wireless unit comprising:
a plurality of antennas comprising antennas having at least two different antenna patterns;
an antenna selector comprising a plurality of ports each coupled to a respective one of the plurality of antennas and a control port to accept a control signal to select at least one of the plurality of antennas;
an inertial sensor comprising a data port to provide orientation information indicative of the orientation of the wireless unit; and
a processor coupled to the data port of the inertial sensor and coupled to the control port of the antenna selector, wherein the processor is configured to generate the control signal based on the orientation information.

2. The wireless unit of claim 1, wherein the plurality of antennas comprises a directional antenna and a hemispheric antenna.

3. The wireless unit of claim 1, wherein the control signal, based on the orientation information, comprises a control signal to select which of the plurality of antennas is expected to provide a strongest signal between the wireless unit and a remote transmitter assumed to be located horizontally from the wireless unit.

4. The wireless unit of claim 1, wherein the control signal based on the orientation information comprises a control signal based on which of the plurality of antennas is expected to provide a strongest signal between the wireless unit and a remote transmitter assumed to be located vertically above from the wireless unit.

5. The wireless unit of claim 1, further comprising a receiver configured to receive an information signal, wherein the processor is further configured to determine an absolute location of a remote transmitter based on the information signal.

6. The wireless unit of claim 5, wherein the control signal based on the orientation information is further based on the absolute location of the remote transmitter.

7. The wireless unit of claim 5, wherein the remote transmitter comprises a base station.

8. The wireless unit of claim 5, wherein the remote transmitter comprises a positioning satellite.

9. The wireless unit of claim 8, wherein the positioning satellite comprises a global positioning satellite (GPS).

10. The wireless unit of claim 1, wherein the inertial sensor comprises an accelerometer.

11. The wireless unit of claim 1, wherein the inertial sensor comprises a gyroscope.

12. A wireless unit to combine signals, the wireless unit comprising:
a plurality of antennas comprising at least one directional antenna;
an inertial sensor comprising a data port to provide orientation information indicative of the orientation of the wireless unit;
a combiner comprising a plurality of input ports each coupled to at least one of the plurality of antennas and further comprising a control port to receive a control signal used to combine signals from the plurality of input ports; and
a processor coupled to the data port of the inertial sensor and coupled to the control port of the combiner, wherein the processor is configured to generate the control signal based on the orientation information.

13. The wireless unit of claim 12, wherein the plurality of antennas comprises antennas having at least two different antenna patterns.

14. The wireless unit of claim 12, wherein the plurality of antennas comprises a directional antenna and a hemispheric antenna.

15. The wireless unit of claim 12, further comprising:
a receiver configured to receive an information signal, wherein the processor is further configured to determine an absolute location of a remote transmitter based on the information signal;
wherein the control signal based on the orientation information is further based on the absolute location of the remote transmitter.

16. The wireless unit of claim 15, wherein the remote transmitter comprises a base station.

17. The wireless unit of claim 15, wherein the remote transmitter comprises a positioning satellite.

18. The wireless unit of claim 17, wherein the positioning satellite comprises a global positioning satellite (GPS).

19. The wireless unit of claim 12, wherein the combiner comprises a non-coherent combiner.

20. The wireless unit of claim 19, wherein the control signal comprises at least one variable weight (wᵢ).

21. The wireless unit of claim 12, wherein the combiner comprises a coherent combiner.

22. The wireless unit of claim 21, wherein the control signal comprises at least one variable phase adjustment signal (ΔΦᵢ).

23. The wireless unit of claim 13, wherein the inertial sensor comprises an accelerometer.

24. The wireless unit of claim 12, wherein the inertial sensor comprises a gyroscope.

25. A method to combine signals using a wireless unit, the method comprising:
providing a plurality of antennas comprising at least one directional antenna;
sensing, using an inertial sensor, an orientation of the wireless unit and generating orientation information indicative of the orientation of the wireless unit;
generating a control signal based on the orientation information; and
combining signals from a plurality of antennas based on the control signal.

26. The method of claim 25, further comprising:
receiving an information signal; and
determining an absolute location of a remote transmitter based on the information signal;
wherein the act of combining the signals from the plurality of antennas based on the control signal is further based on the absolute location of the remote transmitter.

27. The method of claim 26, further comprising:
determining a relative direction from the wireless unit to the remote transmitter;
wherein the act of generating the control signal based on the orientation information comprises generating the control signal based on the relative direction.

28. The method of claim 26, further comprising:
determining an angle between a reference orientation of the wireless unit and an angle to the remote transmitter;
wherein the act of generating the control signal based on the orientation information comprises generating the control signal based on the determined angle.

29. The method of claim 25, wherein the control signal comprises at least one variable weight (wᵢ).

30. The method of claim 25, wherein the control signal comprises at least one variable phase adjustment signal (ΔΦᵢ).

31. A wireless unit to combine signals, the wireless unit comprising:
means for providing a plurality of antennas comprising at least one directional antenna;
means for sensing, using an inertial sensor, an orientation of the wireless unit and for generating orientation information indicative of the orientation of the wireless unit;
means for generating a control signal based on the orientation information; and
means for combining signals from a plurality of antennas based on the control signal.

32. The wireless unit of claim 31, further comprising:
means for receiving an information signal; and
means for determining an absolute location of a remote transmitter based on the information signal;
wherein the means for combining the signals from the plurality of antennas based on the control signal is further based on the absolute location of the remote transmitter.

33. The wireless unit of claim 32, further comprising:
means for determining a relative direction from the wireless unit to the remote transmitter;
wherein the means for generating the control signal based on the orientation information comprises means for generating the control signal based on the relative direction.

34. The wireless unit of claim 32, further comprising:
means for determining an angle between a reference orientation of the wireless unit and an angle to the remote transmitter;
wherein the means for generating the control signal based on the orientation information comprises means for generating the control signal based on the determined angle.

35. The wireless unit of claim 31, wherein the control signal comprises at least one variable weight (wᵢ).

36. The wireless unit of claim 31, wherein the control signal comprises at least one variable phase adjustment signal (ΔΦᵢ).

37. A computer-readable product comprising a computer-readable medium comprising:
code to cause at least one computer to sense, using an inertial sensor, an orientation of a wireless unit and to generate orientation information indicative of the orientation of the wireless unit;
code to cause at least one computer to generate a control signal based on the orientation information; and
code to cause at least one computer to combine signals from a plurality of antennas based on the control signal.

38. The computer-readable product of claim 37, wherein the computer-readable medium further comprises:
code to cause at least one computer to determine an absolute location of a remote transmitter based on a received information signal;
wherein the code to cause at least one computer to combine the signals from the plurality of antennas based on the control signal is further based on the absolute location of the remote transmitter.

39. The computer-readable product of claim 37, wherein the computer-readable medium further comprises:
code to cause at least one computer to determine a relative direction from the wireless unit to the remote transmitter;
wherein the code to cause at least one computer to generate the control signal based on the orientation information comprises code to cause at least one computer to generate the control signal based on the relative direction.

40. The computer-readable product of claim 37, wherein the computer-readable medium further comprises:
code to cause at least one computer to determine an angle between a reference orientation of the wireless unit and an angle to the remote transmitter;
wherein the code to cause at least one computer to generate the control signal based on the orientation information comprises code to cause at least one computer to generate the control signal based on the determined angle.

41. The computer-readable product of claim 37, wherein the control signal comprises at least one variable weight (wᵢ).

42. The computer-readable product of claim 37, wherein the control signal comprises at least one variable phase adjustment signal (ΔΦᵢ).
